(19) United States
(12) Patent Application Publication
(10) Pub. No.: US 2007/0231011 A1
(43) Pub. Date: Oct. 4, 2007

(54) DEVELOPMENT APPARATUS

(75) Inventor: Katsuya NOSE, Toride-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/677,218

(22) Filed: Feb. 21, 2007

(30) Foreign Application Priority Data
Mar. 30, 2006 (JP) 2006-093254

(51) Int. Cl. G03G 15/01; G03G 15/08

(52) U.S. Cl. 399/227; 399/258

(57) ABSTRACT

There is provided a development apparatus including a plurality of replenishment developer containers which accommodates a replenishment developer containing a toner to be replenished to a plurality of development devices, a plurality of replenishment developer conveyance paths which replenishes the replenishment developer in the plurality of replenishment developer containers to the plurality of development devices, a plurality of conveyance members provided in the plurality of replenishment developer conveyance paths, wherein a length of at least one conveyance path, of the plurality of replenishment developer conveyance paths, is different from that of other conveyance paths, and cohesion degree of a replenishment developer conveyed by the longest conveyance path, of the plurality of replenishment conveyance paths, is lower than cohesion degree of the replenishment developer conveyed by other conveyance paths.

### BACKGROUND OF THE INVENTION

1. Field of the Invention

The present invention relates to a development apparatus of an electrophotographic image forming apparatus utilizing electrophotographic type such as copying machine, laser beam printer, facsimile and complex machine (hereafter referred simply to as “image forming apparatus”)

2. Related Background Art

In an image forming apparatus utilizing electrophotographic type or electrostatic recording type, a latent image is formed on a electrostatic latent image bearing member, for example, a photosensitive drum, and a visible image is obtained by attaching a developer (toner) to this latent image. Particularly, in a color image forming apparatus for forming chromatic color images, development method using two component developer including toner and carrier is used widely since stability of image quality and durability of the apparatus are superior to those of other development method.

In development method using two-component developer, of nonmagnetic one component toner and magnetic carrier (hereafter referred simply to as “toner and carrier”) being charged in the development apparatus, toner alone is being consumed for development of electrostatic latent image. Therefore, toners should be replenished freshly one by one to the development apparatus for each of colors. In order to maintain an electrostatic latent image at a predetermined development concentration all the time, an amount of the toner to be replenished should be controlled strictly. For example, when the toner is replenished from toner cartridges corresponding to each of Y, M, C and K colors to the development apparatus, generally, those with such a structure that the toner is fed in pushing manner by rotating a powder conveyance screw having spiral structure which is provided for every color, and the conveyance amount is controlled, have been frequently used. Reasons why the powder conveyance screw is frequently used are that the conveyance amount per one rotation of the screw can be determined easily with simple structure thereof and that necessary controls can be accomplished with reduced costs.

In recent years, it has been requested that images with various image ratios, from large images having large image area such as photographs to small images having small image area such as one-point-color, should be output at high speed and with stable manner. In this case, use of above-mentioned powder conveyance screw for toner replenishment (hereafter referred to as “toner conveyance screw”) involves the following problems:

As for the toner conveyance screw, a screw shaft equipped with a blade in spiral form is penetrated thorough a screw pipe and is rotated to feed the toner in pushing manner by the spiral blade in the pipe. A minimal allowance clearance is provided between outside diameter of the spiral blade and inside diameter of the screw pipe so as to enable rotating the spiral blade. In some cases, so-called flashing phenomenon in which the toner leaks out from such clearance and is supplied more than necessary to the development apparatus, is generated, thereby posing a problem. In order to solve this flashing phenomenon problem, a toner replenishment apparatus which regulates toner amount by adjusting the clearance is proposed (see, for example, Patent Document 1).

[Patent Document 1] Japanese Patent Application Laid-Open No. 5-224530

However, even when toner amount is regulated by adjusting the clearance as is the case of the toner replenishment apparatus disclosed in the patent publication of above-mentioned patent document, there still remain unresolved problems.

In recent years, from view points of higher image quality, energy saving and speeding up of copying operation, there has been a tendency towards smaller diameter particles and lower melting point for the toner. Therefore, toners with higher degree of cohesive force (or sticking power) which is one of factors for determining the powder fluidity, namely, higher cohesion degree toners, have been frequently used. Therefore, when runout or eccentricity is caused to the toner conveyance screw under rotating, toner is ground in the clearance with regard to the screw pipe, thereby generating toner cohesion clusters. These toner cohesion clusters result in defective images such as void image or stain on the image. Particularly, with copying machines in which a toner conveyance screw is used frequently to replenish toner from a toner cartridge to a development apparatus, suppression of generation of cohesion cluster as mentioned poses a significant problem.

In addition, as a known development method in color image forming apparatus, rotary type development unit is mentioned. For example, this method has such a configuration that a plurality of development apparatuses corresponding to each of Y, M, C, K are equally distributed on the same circumference in a radial pattern and are displaced in rotational manner and are rotated to a position facing with an electrophotographic photosensitive drum (hereafter referred simply to as “photosensitive drum”) that is a latent image bearing member to initiate development. In this case, for example, cartridges to which each color of Y, M, C, K toner are charged are arranged in one row in tandem manner and are provided at upper portion of a rotary type development unit to increase the amount of toner accommodation as much as possible.

In this case, each of the development apparatus corresponding to Y, M, C, K arranged in radial manner in the rotary type development unit which is a rotating body is connected through a toner replenishment path to each of those corresponding to a plurality of cartridges arranged in one row at upper port ion thereof. Therefore, it is natural from geometrical viewpoints that there is a dimensional difference between each of length of the replenishment path corresponding to Y, M, C, and K. Thus, a toner conveyance screw is arranged to each of toner replenishment paths having dimensional differences to form a part of the replenishment path, and therefore, length of the screw shaft and length of the screw pipe are also different for Y, M, C, and K. If length of toner conveyance screw is different for Y, M, C, K, there is also a difference of the time for the toner to pass through the screw pipe resulting in a difference of generation of toner cohesion clusters. In other words, replenishing the toner of the same component uniformly from the toner cartridge to each of development apparatuses does not constitute a fundamental solution for suppression of generation of toner cohesion clusters and for prevention of defective images due to void image or stain.

### SUMMARY OF THE INVENTION

An object of the present invention is to provide a development apparatus capable of obtaining a stable image by suppressing effectively generation of cohesion clusters of the toner thereby preventing occurrence of defective images.

A development apparatus to accomplish the above-mentioned object comprises:

a plurality of development devices which develops an electrostatic image;

a plurality of replenishment developer containers each of which accommodates a replenishment developer containing a toner to be replenished to each of the plurality of development devices;

a plurality of replenishment developer conveyance paths which communicates the plurality of replenishment developer containers with the plurality of development devices, and which replenishes the replenishment developer in the plurality of replenishment developer containers to each of the plurality of development devices; and

a plurality of conveyance members which are provided in each of the plurality of replenishment developer conveyance paths for conveying the replenishment developer;

wherein a length of at least one conveyance path, of the plurality of replenishment developer conveyance paths, is different from that of other conveyance paths, and cohesion degree of replenishment developer to be conveyed by a longest conveyance path, of the plurality of replenishment developer conveyance paths, is lower than cohesion degree of replenishment developer to be conveyed by other conveyance path

### BRIEF DESCRIPTION OF THE DRAWINGS

FIG. 1 is a drawing illustrating apart of an image forming apparatus equipped with a development unit according to an embodiment.

FIG. 2 is a drawing illustrating a toner replenishment path for every color from a toner cartridge which is a main part in the development unit according to the present embodiment, to a rotary type development unit.

FIG. 3 is a drawing schematically illustrating replenishment of toners with preferred cohesion degree capable of preventing toner cohesion clusters corresponding to hopper replenishment screws having different length for each of colors.

FIG. 4 shows Table 1, Table 2, Table 3 in which measurements in the first embodiment are summarized.

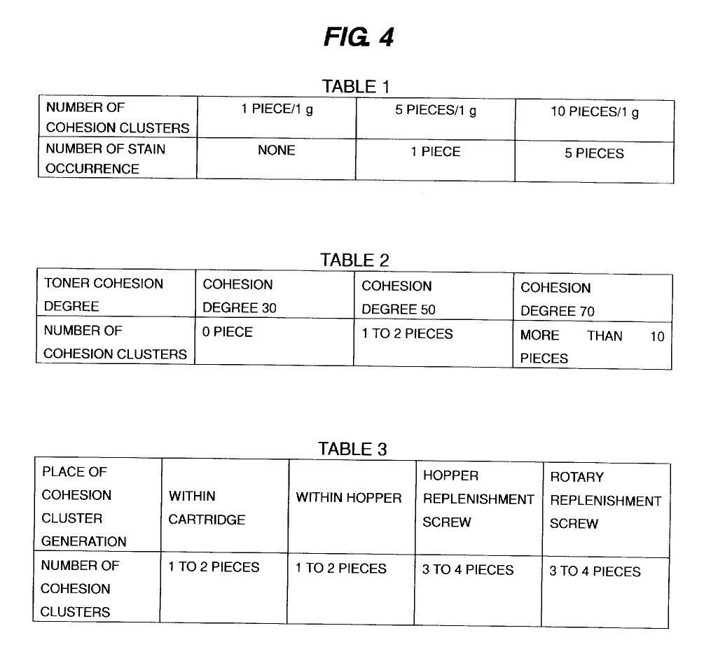

FIG. 5 shows Table 4, Table 5 in which measurements in the first embodiment are summarized.

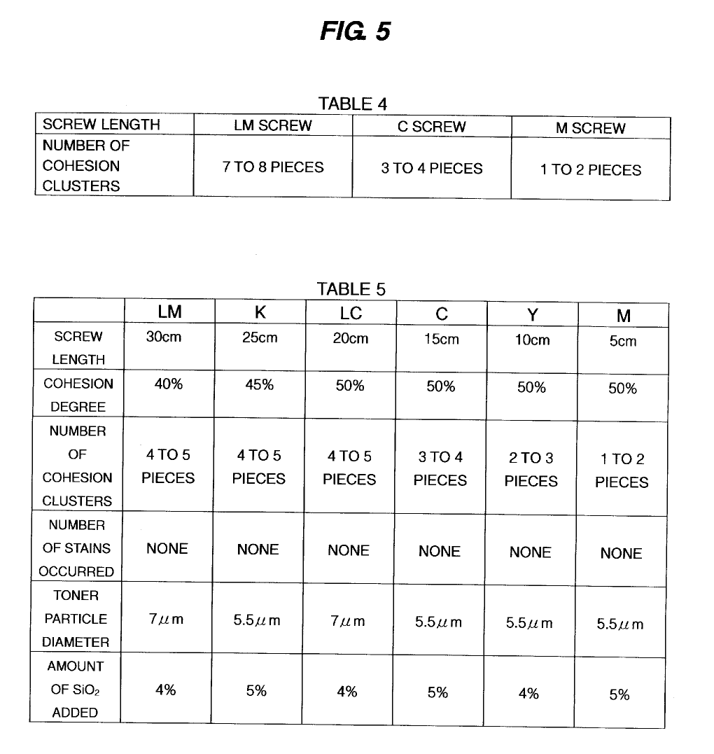

FIG. 6 shows Table 6, Table 7 in which measurements in the second embodiment are summarized.

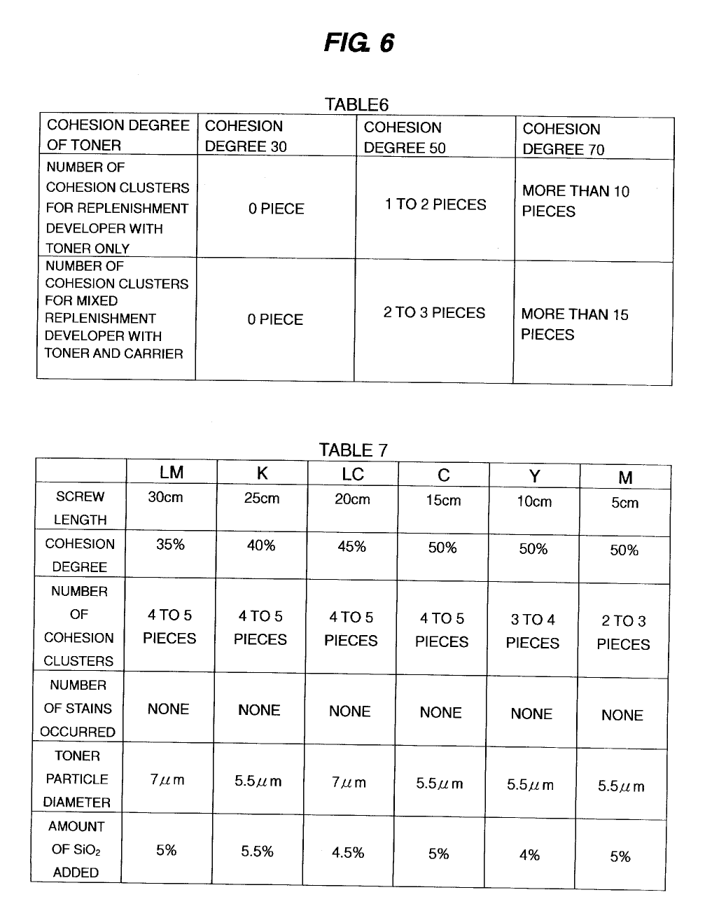

### DETAILED DESCRIPTION OF THE EMBODIMENTS

Now, referring to drawings, each one exemplary embodiment of the development unit and the image forming apparatus according to the present embodiment is described in detail hereafter.

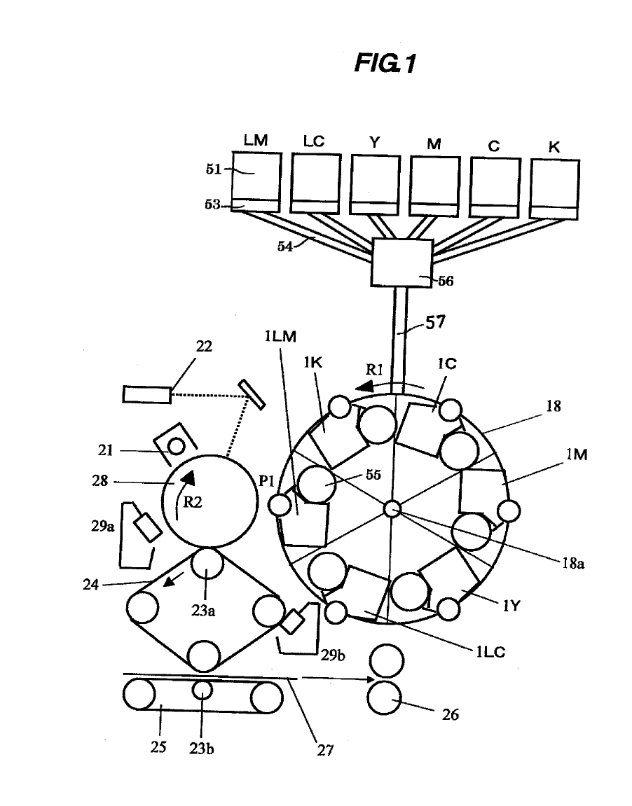

FIG. 1 illustrates an image forming apparatus having a rotary type development apparatus 18 which has cylindrical form and is rotatable (hereafter referred simply to as “development unit”). On the circumference about a rotating shaft 18a of the development unit 18, for example, development devices 1Y, 1M, 1C and 1K corresponding to each color of Y (yellow), M (magenta), C (cyan), K (black), development device 1LM for light magenta, development device 1LC for light cyan are equally distributed in radial manner. Meanwhile, light magenta and light cyan are color having the same hue with regard to magenta and cyan, respectively, and low density (light color). By performing development with a combination of such a light color toner and deep color toner, granularity of images can be improved. Hereafter, these are collectively named as a development device 1 except otherwise necessary. The development unit 18is rotated upon receiving rotational power from a motor (not shown) which serves as a rotational power source. By the rotation, an arbitrary development device 1 is displaced to a proximity position for process action to a photosensitive drum 28 which is a latent image bearing member while the another development devices 1 are retreated from a photosensitive drum 28.

The image forming apparatus operates follows:

In FIG. 1, a primary charger 21 applies a charged bias voltage to charge the surface of the photosensitive drum 28 and forms an electrostatic latent image on the photosensitive drum 28 by exposure unit such as a laser scanner 22. The development apparatus 1 forms a toner image on the electrostatic latent image on the photo sensitive drum 28, and this toner image is transferred on an intermediate transfer belt 24 by a first transfer bias by a first transfer charger 23a.

When a full color image is to be formed, for example, first, a toner image of light magenta is formed on the photosensitive drum 28 by a development apparatus 1LM for light magenta, and the light magenta toner image is then primary transferred on the intermediate transfer belt 24. Subsequently, a rotary type development body 18 is displaced in rotational manner by an angle of 60° to bring the development apparatus 1LC for light cyan to a development position P1. A toner image of light cyan is formed on the photosensitive drum 28, and the toner image of light cyan is superimposed onto the toner image of light magenta mentioned above on the intermediate transfer belt 24 by way of primary transfer. Such operations are executed sequentially in the development apparatuses 1Y, 1M, 1C, 1K to form full color images based on chromatic toner onto the intermediate transfer belt 24.

Following this, by second transfer bias by way of a second transfer charger 23b, images on the intermediate transfer body belt 24 are collectively secondary transferred onto a sheet 27 such as recording paper on a transfer paper conveyance belt 25, and the sheet 27 is released from the transfer paper conveyance belt 25. It is then fed to a fixing device 26 and fixed by pressurizing and heating to obtain a permanent image. Further, toner remained on the photosensitive drum 28 after primary transfer is removed by a first cleaner 29a, and toner remained on the intermediate transfer belt 24 after secondary transfer is removed by a second cleaner 29b, to be in stand by state for the next image forming.

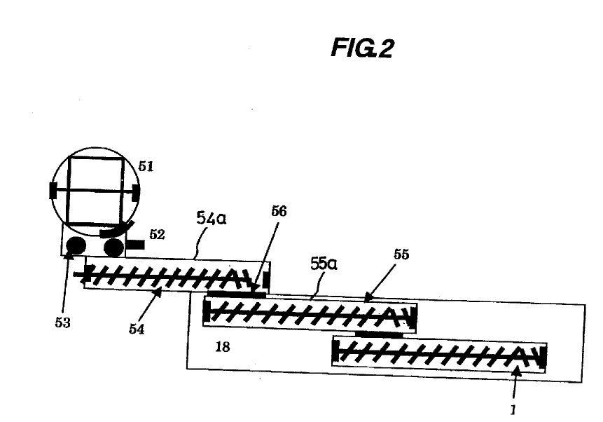

Referring to FIG. 1 and FIG. 2, the conveyance path for conveying the toner by the replenishment developer conveyance path from a toner cartridge (replenishment developer container) 51, in which toner of each color LM, LC, Y, M, C, K is charged, to the rotary type development unit 18 will be described.

At upper portion of the development unit 18, large capacity toner cartridges 51 is arranged in single horizontal row in tandem manner in the order of, for example, image forming by each color LM, LC, Y, M, C, K. Besides, a hopper 53 for replenishing the toner to each development apparatus 1 is provided for every toner cartridge 51, and a piezo-sensor 52 for detecting the toner is provided inside of each hopper. When output of atoner detection signal from the piezo-sensor 52 is ceased, control is made so that the toner is fed from the toner cartridge 51 to the hopper 53 inside. The toner in the hopper 53 is supplied to inside the development unit 18 by rotational driving of a hopper replenishment screw (conveyance member) 54 in pushing manner. In other words, the hopper replenishment screw 54 has a screw shaft onto which a blade is formed in spiral form, rotational speed (revolution: rpm) of the shaft is controlled by an automatic toner replenishment apparatus (ATR), and the toner is replenished to the target development unit 18 while rotating at a desired rotational speed.

As shown in FIG. 2, the toner being fed from the hopper replenishment screw 54 in pushing manner is delivered to a rotary replenishment screw (conveyance member) 55 corresponding to each of the development device 1 in the development unit 18. The toner is replenished thoroughly to each of the development device 1 by the rotary replenishment screw 55 thereof In this way, the replenishment developer conveyance path communicates the developer replenishment container 51 with the development device 1, provides with conveyance members (54, 55) therein, and serves as the replenishment route (54a, 55a) for replenishment of the replenishment developer in the developer replenishment container to the development device 1. Meanwhile, length of the replenishment conveyance path corresponds to a length of the replenishment route (54a, 55a).

As for toner replenishment method for the above-mentioned case, it is possible to employ a video counting type ATR which predicts toner consumption by measuring laser exposure time. As for performance of toner replenishment of this type, replenishment accuracy represented by variation of amount of replenishment per unit number of times of replenishment or by unit time affects image density and particularly affects tint stability. For this reason, an encoder is disposed at the most upperstream side of the hopper replenishment screw 54, and rotational speed of the hopper replenishment screw 54 is controlled based on the signal from this encoder.

The amount of toner replenishment obtained when the hopper replenishment screw 54 is rotated one time is defined to be “One replenishment unit”. When replenishment time is controlled by above-mentioned toner replenishment method, variation of the replenishment amount expressed by thus defined unit can be reduced to approximately 1/10 of variation of the replenishment amount by conventional method. To attain this level, it is necessary to charge an equal amount of replenishment toner all the time to every screw pitch of the hopper replenishment screw 54. In addition, the replenishment toner should be being charged while inside of the screw pipe 54a, through which screw shaft of the hopper replenishment screw 54 is penetrated, is sealed reasonably all the time. In the meantime, with allowable tolerance clearance provided between outside diameter of spiral blade of screw shaft of the hopper replenishment screw 54 and inside diameter of the screw pipe 54a, it has been reported that rubbing and grinding of the replenishment toner occur. On the other hand, the replenishment toner fed from the rotary replenishment screw 55 to inside the development unit 18 is being fed entirely to the development apparatus 1 at the time of replenishment. Therefore, rubbing and grinding of the replenishment toner at the clearance between outside diameter of spiral blade of the rotary replenishment screw 55 and inside diameter of the screw pipe 55a occur very rarely.

Next, toner cohesion clusters which may cause defective images due to void image or stain are generated by rubbing with inner circumference of the screw pipe 54a, 55a, or generated by electrostatic cohesion of toner themselves. In general, when rubbing time is long, defective images are caused more easily under low-humidity environments than high humidity environments. As for size of cohesion clusters, cohesion clusters more than 1 mm in diameter are present while particle diameter of ordinary toner is 5.5 μm. If these cohesion clusters are replenished to inside the development unit 18, although majority of clusters can be crushed by the rotary replenishment screw 55, larger particles or cohesion clusters with higher cohesiveness can not be crushed, but are subjected to development. As a result, images with drip-drop stain appear as defective images. If it is extremely difficult to eliminate cohesion clusters thoroughly, allowable extent of generation of the cohesion clusters will be analyzed hereafter based on the measurements.

### (Measurement of Cohesion Degree)

As one of methods to know the degree of cohesion, flow characteristics of a sample representing the replenishment developer are measured. The basis of determination is such that the greater the cohesion degree is, the more likely the sample has “Defective fluidity” as the replenishment developer. The sample as the replenishment developer denotes in some cases a single body including non-magnetic toner alone, or an admixture of non magnetic toner and magnetic carrier, or in another case, toner containing external additive. The external additive is fine powders and is used as the toner surface modifier, and in recent years, it is used, in some cases, as the image density improving agent. The object of cohesion degree in the present invention is a state as the toner containing the additive. With a developer in which magnetic carrier and no-magnetic toner are mixed, measurement of the cohesion degree is performed for non magnetic toner excluding magnetic carrier.

### Embodiment 1

Powder tester (Hosokawa Micron Corporation) equipped with digital vibration meter (Digivibro Model 1332) was used as the measuring device. On the vibration stand sieves having 380 mesh, 200 mesh, 100 mesh in the order of finer mesh were laminated so that 100 mesh sieve may be positioned at the uppermost. 5 g of precisely weighed sample was added on the 100 mesh sieve thus set, displacement of the digital vibration meter was set to 0.5 mm (peak-to-peak), and vibrations were exerted for 15 sec. After that, weight of the sample left on each of sieves was measured and measurement was substituted in Equation (1) shown below to calculate cohesion degree. Samples used were left under 23° C./60% RH environment for about 12 hours, and measurement environment was 23° C./60% RH.

Cohesion degree (%) (Weight of sample on 100 mesh sieve/5 g)×100×(1/1)+(Weight of sample on 200 mesh sieve/5 g)×100×(3/5)+(Weight of sample on 380 mesh sieve/5 g)×100×(1/5) (1)

### (Measurement of Cohesion Clusters in Replenishment Developer Sample)

The number of cohesion clusters is measured to know how many cohesion clusters, which result in defective images such as void image or stain in the sample.

First, a sieve having 75 μm of opening was set on the vibration stand, 1 g (gram) of precisely weighed sample toner was added onto this mesh sieve, amplitude of vibration was adjusted to 5 mm, and vibrations were exerted 800 cycles in 30 sec. Following this, the number of cohesion clusters left on the mesh sieve was counted. This measurement was repeated 10 times and the number of cohesion clusters (sampling average) was calculated.

In the meantime, in order to know possible correlation between the number of such clusters, and defects and imperfections on the image, cohesion clusters collected at actual measurement are mixed directly into the development apparatus, 20 sheets of halftone images were output, and the number of stains appeared on images was actually measured. In this case, cohesion cluster(s) of about 1 mm in size were mixed 1 piece, 5 pieces, 10 pieces with regard to toner replenishment amount of 1 g. Results of the measurement are normalized with respect to the number of pieces of cohesion clusters present in 1 g of the sample toner and are shown in Table 1.

Table 2 through Table 7 described herein as well as Table 1 mentioned above are shown in the separate sheets.

The material used as the sample of replenishment developer was prepared such that resin binders made primarily of polyester were kneaded together with wax and pigments, which were then crushed and classified to obtain ones having average volumetric particle diameter of around 5.5 μm. After that, appropriate amount of additives were added to yield cyan toner having 50% cohesion degree to be used for assessment. It is understood from measurement results shown in Table 1 that the number of cohesion clusters to be mixed in the development apparatus 1 should be less than 5 pieces.

Next, in order to know toner cohesion degree at which cohesion clusters are generated, using toners with cohesion degree of 30%, 50%, 70% (this difference of cohesion degree was generated by changing amount of the additives appropriately) the number of cohesion clusters under room temperature/low-humidity environments (23° C./5%) was measured. For assessment, sample toner to be used as the assessment object was charged in the cartridge, and the number of cohesion clusters in the cartridge was used as the basis of assessment. Results of assessment are shown in Table 2.

It is understood from assessment results shown in Table 2 that samples with higher cohesion degree tend to generate cohesion clusters easily. Therefore, it is possible to suppress generation of cohesion clusters effectively, if toner with cohesion degree less than 30% is used as replenishment developer. However, when toner with lower cohesion degree (less than 30%) is used as the replenishment developer, defective images such as varied transfer at the primary transfer portion due to high fluidity occur and changes in sealed state in the screw pipe 54a of the hopper replenishment screw 54 become excessive, which easily results in variation of the amount of replenishment. On the other hand, when toner with higher cohesion degree (more than 70%) as replenishment developer is used, defective images such as white void due to reduction in development efficiency occur and toner transport efficiency in the screw pipe 54a is reduced remarkably.

In other words, toner as the optimum replenishment developer would be obtained if toner cohesion degree is adjusted to 30% or more and 70% or less, preferably 40% or more and 60% or less. Meanwhile, there are several methods for adjustment of cohesion degree of toners. First, adjustment by toner particle diameter is mentioned. In general, the greater the toner particle diameter is, the lower the cohesion degree is. Further, adjustment by the amount of addition of external additives, for example, SiO₂, is available. In general, the greater the weight ratio with regard to the toner is, the lower the cohesion degree is. Furthermore, cohesion degree is depending on materials of pigments added to the toner to develop toner color. Therefore, it is possible to obtain a desired particle diameter by combining these several factors. It goes without saying that, since alteration of the combination would affect image quality, good balance should be maintained with regard to the image quality. The method for changing cohesion degree is not limited to those mentioned herein.

Meanwhile, in order to identify the place of cohesion cluster generation, the number of cohesion clusters generated was assessed at cyan (C) station in the image forming apparatus. Assessment results are shown in Table 3. It has been confirmed from these assessment results that generation of cohesion clusters is remarkable in the hopper replenishment screw 54 where toner charging rate is the highest and inner circumference of the screw pipe 54a is rubbed intensively. Further, as mentioned previously, since the number of cohesion clusters which permits occurrence of stains in the image forming apparatus is less than 5 pieces, there is no possibility of occurrence of defective images under this condition.

Meanwhile, overall length of the hopper replenishment screw 54 (length of screw pipe 54a) acts as the factor for the difference of degree of generation of cohesion clusters. The primary object of the present invention is to resolve this problem.

As shown in FIG. 1 , each of hopper replenishment screws 54 extending from each of toner cartridges 51 for LM, LC, Y, M, C, K arranged in one row in tandem manner are gathered together at a screw assembly portion 56 to form one complete unit. One common replenishment pipe 57 from the screw assembly portion 56 goes down perpendicularly and is connected to one portion at the top of the development unit 18 which is a rotating body. The most downstream side outlet end of the common replenishment pipe 57 is connected to the rotary replenishment screw 55 of the development apparatus 1 which reached that position by rotational displacement. Thus, “replenishment path” which serves as one replenishment route is formed.

Therefore, each of hopper replenishment screws 54 extending from each of toner cartridges 51 for LM, LC, Y, M, C, K are different in their length to the screw assembly portion 56. Namely, length of the screw shaft and length of the screw pipe 54a composing a part of the replenishment path for every color are different. In order to know how generation of cohesion clusters is affected by each of screw length, the following selection was made:

A screw for magenta which has the shortest length (for example, screw pipe length 50 mm), a screw for cyan having intermediate length (for example, screw pipe length 150 mm), a screw for light magenta having the longest length (for example, screw pipe length 300 mm) were selected. Cyan toner adjusted to have cohesion degree of 50 was charged to each of these screw pipes 54a, and the number of cohesion clusters generated in the toner was observed at the most downstream of the hopper replenishment screws 54 and then subjected to comparing investigation. Comparison results are shown in Table 4. It is known from the comparison results that the number of cohesion clusters generated is greatly associated with screw length.

Next, cyan toner with 50% cohesion degree was charged actually to all color stations and durability assessment of as many as 5,000 sheets was carried out for the sake of image assessment. It was then found that drip-drop stain was caused at stations for LC, K, LM which are longer than the screw length (150 mm) for cyan.

Taking these results into considerations, as Embodiment 1, toners (replenishment developer) with different cohesion degree corresponding to the screw pipe length of the hopper replenishment screw 54 were supplied and investigation was made.

Table 5 shows relationships among characteristics of each toner (cohesion degree, toner particle diameter, amount of addition of SiO₂ (weight ratio of additives with regard to toner weight), length of screw pipe, number of cohesion clusters, and number of stain occurrence during durability assessment.

As it is seen from this table, in Embodiment 1 where length of screw pipe of the hopper replenishment screw 54 is different for each color, light magenta toner (cohesion degree of 40%), which is adjusted so that the cohesion degree might become the lowest, was arranged for light magenta screw which had the longest screw pipe 54a. Particle diameter of light magenta toner was set to 7 μm, which was greater than particle diameter of magenta toner of 5.5 μm, to reduce cohesion degree to be lower than that of magenta toner. Although the amount of addition of SiO₂ for magenta toner was greater, lower cohesion degree was obtained since the factor of particle diameter was dominant. The difference in cohesion degree of the magenta toner from that of light cyan toner is attributable to the difference of pigments added to the toner. Besides, for K, LC toners which exceeded the allowable level of the number of cohesion clusters for stain occurrence, generation of toner cohesion clusters could be suppressed and defective images such as void image or stain could be prevented by adjusting the cohesion degree of K, LC toners appropriately.

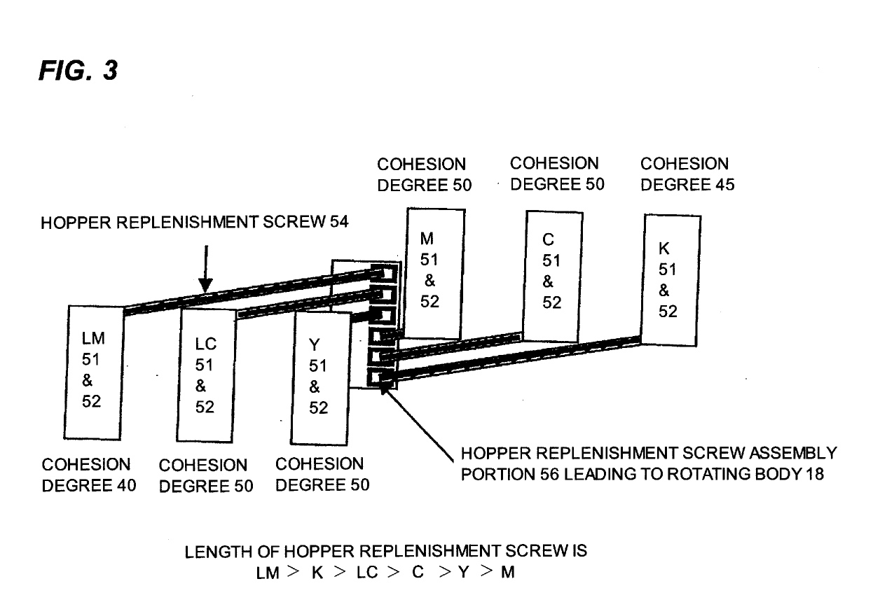

FIG. 3 is a drawing schematically illustrating construction of exemplary Embodiment 1 for the development unit according to the present embodiment.

### Embodiment 2

A development unit, in which replenishment developer (mixture of toner and carrier) is charged to the toner cartridge 51, is frequently provided to a real machine of image forming apparatus. In this case, by replenishing a mixture of the toner and carrier, carrier deteriorated from durability viewpoints is replaced with new carrier thereby lengthening toner service life.

When toner is solely used as the replenishment developer, and is compared to the replenishment developer based on mixing of the toner and carrier, since carriers having negative charge of the toner and toners attract each other by Coulomb attraction, electrostatic cohesion is easily caused, and cohesion clusters are easily generated. Then, for cases where a mixture of the toner and carrier is used, and where toner is solely used as the replenishment developer, the number of cohesion clusters generated was compared in relation to toner cohesion degree. Specifically, the number of cohesion clusters was measured using cyan toners with above-mentioned cohesion degree of 30, 50, 70. Assessment toner, and mixture of assessment toner and carrier were charged in the cartridge for assessment, and the number of cohesion clusters in the cartridge was counted.

Assessment results are shown in Table 6. It was found from the assessment results that, in the case of replenishment developer based on mixing of the toner and carrier, the toner with higher cohesion degree generate cohesion clusters more remarkably than the case of replenishment developer including toner only. The fact that the place of cohesion cluster generation is the hopper replenishment screw 54 and that there is a tendency that cohesion degree is fixed, the longer the screw length, the more cohesion clusters are generated, are identical for both cases; replenishment developer is based on mixing of the toner and carrier, and replenishment developer including toner only.

In Embodiment 2, similarly to above-mentioned Embodiment 1, investigation was made by supplying a replenishment developer which is a mixture of a toner having different cohesion degree depending on screw length of the toner replenishment screw 54 and carrier. As a result, 4 pieces of cohesion clusters or more are generated at each of stations LM, K, LC. Durability assessment using 5,000 sheets was carried out, drip-drop stain occurs. Then, further investigation was made using toners with lower cohesion degree prepared depending on length of the screw. Table 7 shows relationships among toner of each color, screw length, number of cohesion clusters, and number of stain occurrence during durability assessment. In the present embodiment, these cohesion degrees were obtained by adjusting the added amount of SiO₂ with regard to Embodiment 1. As a result, it was found that in the case where replenishment developer is a mixture of the toner and carrier, cohesion degree of the toner should be reduced much more than that necessary for the case where replenishment developer includes toner alone. From above discussions, while screw pipe length of the hopper replenishment screw 54 is different for each of colors, for light magenta screw having the longest screw pipe length, a mixture of light magenta including light magenta toner (cohesion degree 35%) which is adjusted to attain the minimal cohesion degree, and carrier was applied. For K and LC toners which exceeded the allowable level of the number of cohesion clusters for stain occurrence, generation of toner cohesion clusters could be suppressed and defective images such as void image or stain could be avoided by adjusting cohesion degree appropriately.

Although the embodiment of the development unit according to the present invention is described as mentioned above by citing Embodiments 1, 2, it is to be understood that the present invention is not limited thereto, and covers other embodiments, modifications, variations and combination thereof as long as they come within the scope of the present invention. Further, although concrete examples of the measurements are shown as Embodiments 1, 2, the present invention is of course not represented by these measurements.

This application claims the benefit of priority from the prior Japanese Patent Application No. 2006-093254 filed on Mar. 30, 2006 the entire contents of which are incorporated by reference herein.

1. A development apparatus comprising:
a plurality of development devices which develops an electrostatic image;
a plurality of replenishment developer containers each of which accommodates replenishment developer containing a toner to be replenished to each of the plurality of development devices;
a plurality of replenishment developer conveyance paths which communicates the plurality of replenishment developer containers with the plurality of development devices, and which replenishes the replenishment developer in the plurality of replenishment developer containers to each of the plurality of development devices; and
a plurality of conveyance members which are provided in each of the plurality of replenishment developer conveyance paths for conveying the replenishment developer;
wherein a length of at least one conveyance path, of the plurality of replenishment developer conveyance paths, is different from that of other conveyance paths, and cohesion degree of replenishment developer to be conveyed by a longest conveyance path, of the plurality of replenishment developer conveyance paths, is lower than cohesion degree of replenishment developer to be conveyed by other conveyance path.

2. The development apparatus according to claim 1,
wherein particle diameter of replenishment developer to be conveyed by the longest conveyance path, of the plurality of replenishment developer conveyance paths, is larger than particle diameter of replenishment developer to be conveyed by other conveyance path.

3. The development apparatus according to claim 1,
wherein cohesion degree of the replenishment developer is 30% or more and 70% or less.

4. The development apparatus according to claim 1,
wherein cohesion degree of the replenishment developer is 40% or more and 60% or less.

5. The development apparatus according to claim 1,
wherein the plurality of conveyance members have screw profile, and outside diameter of the plurality of conveyance members and inside diameter of the plurality of replenishment developer conveyance paths are arranged so as to have a predetermined clearance.
